(19) United States
(12) Patent Application Publication
(10) Pub. No.: US 2023/0180679 A1
(43) Pub. Date: Jun. 15, 2023

(54) SIMPLIFIED COTTON CULTIVATION METHOD RELYING ON FRUITING (BOLL SETTING) ON VEGETATIVE BRANCHES

(71) Applicant: Shandong Academy of Agricultural Sciences, Shandong Province (CN)

(72) Inventors: HEZHONG DONG, Shandong Province (CN); JUNJUN NIE, Shandong Province (CN); YANJUN ZHANG, Shandong Province (CN); JIANLONG DAI, Shandong Province (CN); ZHENGPENG CUI, Shandong Province (CN); DONGMEI ZHANG, Shandong Province (CN); LIJIE ZHAN, Shandong Province (CN)

(21) Appl. No.: 17/868,876

(22) Filed: Jul. 20, 2022

(30) Foreign Application Priority Data
Dec. 9, 2021 (CN) 202111497533.1

(51) Int. Cl. A01G 22/50; A01G 13/02

(52) U.S. Cl. CPC A01G 22/50; A01G 13/0262

(57) ABSTRACT

The present disclosure provides a simplified cotton cultivation method relying on setting bolls on VBs. Not only can the method form seed cotton yield and increase the yield by at least 10% compared with conventional manual pruning or no-prune technique, but also eliminate pruning and topping. The method is a new, simple and feasible simplified cotton cultivation method. The simplified cotton cultivation method relying on setting bolls on VBs includes the following steps: heading a cotton plant to retain only VBs when cotton grows to squaring stage, namely cutting off the first fruiting branch and an upper main stem thereof from the cotton plant after squaring, and only retaining the vegetative branches for growth and development, squaring, flowering, and setting bolls.

### CROSS REFERENCE TO RELATED APPLICATION

This patent application claims the benefit and priority of Chinese Patent Application No. 202111497533.1, entitled “SIMPLIFIED COTTON CULTIVATION METHOD RELYING ON FRUITING (BOLL SETTING) ON VEGETATIVE BRANCHES” filed on Dec. 9, 2021, the disclosure of which is incorporated by reference herein in its entirety as part of the present application.

### TECHNICAL FIELD

The present disclosure relates to a cotton cultivation method, in particular to a simplified cotton cultivation method relying on fruiting (boll setting) on vegetative branches, and belongs to the technical field of cotton cultivation.

### BACKGROUND ART

Cotton is a warm- and light-loving thermophilic and heliophilic crop. In the limited growing season, the formation of high-quality bolls and timely maturation are guarantees for achieving high-yield and high-quality cotton. However, the branching pattern of cotton is complex, including fruiting branches (FB), vegetative branches (VB), and redundant buds. The branching pattern of vegetative branches is monopodial, which are located at the basal part of the cotton main stem and do not bear fruit directly. It is generally believed that vigorous VB often consumes the nutrients of the cotton plant, causing shades in the field, reduces the light and ventilation within the canopy, increases the number of rotten bolls. Although vegetative branches can indirectly set bolls and contribute a part of the economic yield, the fiber quality of the VB-sourced is not as good as that of the FB-sourced bolls. Therefore, the manual removal of VB has been widely applied for decades in cotton production in China.

However, recent studies and practice have shown that the retention of VB does not reduce seed cotton yield while saves the labor costs of VB removal. The retention of VB also increases leaf sources before peak boll-setting and expands boll sinks at the late stages of plant growth under a considerably low plant population density. At a high plant density, VB branching is significantly inhibited due to a set of illumination and spectral characteristics changes, thereby reducing the process of removal of VBs without reducing yield. However, these studies were all aimed at harvesting bolls from FB, and did not compare the productivity of cotton vegetative branches and fruiting branches. Until now, it is unclear whether it cannot reduce or even increase yield by completely relying on VB-sourced bolls.

### SUMMARY

An objective of the present disclosure is to provide a simplified cotton cultivation method completely relying on fruiting on VBs. The method of present disclosure completely relying on setting bolls on VBs provided by the present disclosure can form seed cotton yield and increase the yield by at least 10% on average compared with the traditional manual pruning or the current no pruning technology, but also eliminate plant pruning and topping processes. The present method is a new, simple and feasible simplified cotton cultivation method.

To achieve the above objective, the present disclosure is implemented by the following technical solution:

a simplified cotton cultivation method relying on setting bolls on VBs, including the following steps: heading a cotton plant to retain only VBs when cotton grows to squaring stage, namely cutting off the first fruiting branch and its upper main stem after squaring, and only retaining the VBs for growth and development, squaring, and setting bolls.

In an embodiment, the simplified cotton cultivation method relying on setting bolls on VBs, the cotton is sown on April 10 to 20 and cultivated with plastic mulching.

In an embodiment, the simplified cotton cultivation method completely relying on setting bolls on VBs, cotton planting density is around 30,000 plants ha′.

In an embodiment, the simplified cotton cultivation method completely relying on setting bolls on vegetative branches, further pruning and topping are no longer conducted during the cotton developmental stage.

In an embodiment, the simplified cotton cultivation method completely relying on setting bolls on vegetative branches, a compound fertilizer (N: P₂O₅: K₂O=15%: 15%: 15% in weight percentage) of 450 kg ha′ was basal applied before seeding, with a topdressed urea at 225 kg ha′ after the cotton is headed, and no top-dressing thereafter.

In an embodiment, the simplified cotton cultivation method completely relying on setting bolls on vegetative branches, chemical control is conducted twice during the growth period of cotton: 22.5-30 kg and 45-60 kg of mepiquat chloride are each sprayed per hectare at the time of early flowering and when the first boll appeared, spraying is no longer needed thereafter.

The present disclosure has the following advantages:

The method relying on setting bolls on VBs provided by the present disclosure is implemented by cutting off the first fruiting branch and its upper main stem after squaring, and only retaining the VBs for growth and development, squaring, and setting bolls. By comparing the bolls and yields of VB retention, FB retention, and no pruning, the present disclosure clarifies that cotton can rely on setting bolls on VBs to form yield, which is comparable to or even higher than the yields obtained by setting bolls on FBs (only FB retention) and no pruning. It is indicated that the present disclosure fully mobilizes the self-compensation mechanism and indeterminate growth habit of cotton by cutting off fruiting branches and its upper main stems after squaring, so that VBs grow vigorously, the formation of indirectly fruiting branches is promoted, and the boll density is increased, forming a higher seed cotton yield than (or comparable to) the yield obtained by only FB retention and no pruning. This not only breaks the traditional concept that vegetative branches cannot form comparable yields alone, but also eliminates the need for plant pruning and topping, which is a new and feasible simplified cotton cultivation method.

### DETAILED DESCRIPTION OF THE EMBODIMENTS

As introduced in the Background Art: VBs retention could contribute part of the economic yield by indirectly setting VB-sourced bolls, which had the effect of expanding leaf sources before peak boll-setting and extending boll sinks at the late stages of plant growth under a low plant population density. Under high plant density, VBs branching was significantly inhibited due to a set of illumination and spectral characteristics, thereby reducing the process of removal VBs without reducing yield. However, these studies were all aimed at harvesting bolls from FBs, and did not compare the productivity of cotton vegetative branches and fruiting branches. Until now, it is unclear how much cotton yield can be formed by VB-sourced bolls. In order to solve the above technical problem, the present disclosure provides a simplified cotton cultivation method relying on VB-sourced bolls, including the following steps: heading a cotton plant to retain only VBs, that is the first fruiting branch and its upper main stem of cotton are cut off at the squaring stage, and only retaining the VBs for growth and development, squaring, and setting bolls.

In the present disclosure, the cotton may be sown on April 10 to April 20 and cultivated with mulching.

In the present disclosure, cotton planting density is controlled at 30,000 plants ha⁻¹.

In the present disclosure, pruning and topping are no longer conducted after the cotton is headed.

In the present disclosure, A compound fertilizer (N: P₂O₅: K₂O=15%: 15%: 15% in weight percentage) of 450 kg ha⁻¹ was basal applied before seeding, with a topdressed urea at 225 kg ha⁻¹ after the cotton is headed, and no top-dressing thereafter.

In the present disclosure, chemical control is conducted twice during the growth period of cotton: 22.5˜30 and 45˜60 kg ha′ of mepiquat chloride is sprayed at early flowering and early boll-setting stages, respectively.

Management of the cotton is not particularly limited in the present disclosure, and conventional management can be used.

In order to enable those skilled in the art to better understand the technical scheme herein, the present disclosure will be described in detail below with reference to embosiments. The technical scheme of the present disclosure includes but is not limited to the following examples. Based on the examples of the present disclosure, all other examples obtained by those of ordinary skill in the art without making creative work fall within the claimed scope of the present disclosure.

### Example 1

Delinted and coated cottonseeds were sown on April 15 and planted in an equal row spacing of 76 cm. After cotton seedlings emerged, the seedlings were established and were thinned to 33000 plant ha′ by leaving one vigorous plant per hill at the two-true-leaf stage. The actual plant density at harvest was 29700 plant ha′. A compound fertilizer (N: P₂O₅: K₂O=15%: 15%: 15% in weight percentage) of 450 kg ha′ was basal applied before seeding, with a topdressed urea at 225 kg ha′ after the cotton is headed. Chemical control with mepiquat chloride at a dosage of 30 and 52.5 g ha⁻¹ was carried out at the early flowering and boll-setting stages, respectively. Other field management practices, including irrigation, tillage, and insect and weed control, were conducted according to local agronomic practices.

Plants in the central four rows of each plot were manually harvested. The seed cotton from each plot was weighed after sun-drying to a constant weight. The number of harvested bolls was recorded, and the average boll size was calculated. The seed cotton was ginned in a 10-saw gin, and the lint percentage was obtained. After harvesting completely, 5 plants were randomly selected, removed manually from the soil, and weighed after being air-dried for 20-25 days in a dry room. The biological yield (seed cotton plus stalks and plant debris) and harvest index (seed cotton yield/final biological yield) were then determined. The results were shown in Table 1.

TABLE 1
Effects of plant pruning on cotton yield, yield components and harvest index

| | Boll density | Boll weight | Lint percentage | Seed cotton | Biomass yield | Harvest index |
|---|---|---|---|---|---|---|
| Factors | (No. m⁻²) | (g) | (%) | yield (kg ha⁻¹) | (kg ha⁻¹) | (%) |
| only FB retention | 91.5 c | 4.89 a | 44.33 a | 4474 c | 11064 b | 40.4 a |
| only VB retention | 128.4 a | 4.16 c | 43.58 a | 5342 a | 15668 a | 34.1 b |
| no pruning | 106.8 b | 4.57 b | 43.81 a | 4881 b | 13154 b | 37.1 c |

NOTE:
FB and VB represent fruiting branch and vegetative branch respectively. Values within a column followed by different letters under the same factor in the table indicate significant differences at the p = 0.05.

Results showed that the present cotton cultivation method of completely only relying VB-sourced bolls greatly improved the biomass yield and boll density, which induced the increased of seed cotton yield. Compared with the traditional removal of vegetative branches (only FB retention) and no pruning, the boll density of only VB retention increased by 40.3% and 20.2%, the boll weight decreased by 14.9% and 9.0%, the seed cotton yield increased by 19.4% and 9.4%, the biomass yield increased by 41.6% and 19.1%, and the harvest index decreased by 15.7% and 8.1%, respectively.

### Example 2

A field experiment was conducted at the Experimental Station of Shandong Academy of Agricultural Sciences, Gaotang (116° 23′E, 36° 86′N) Shandong province, which is in the Yellow River Valley cotton-growing region of China. Delinted and coated cottonseeds were planted on April 18 with 76 cm row spacing. After cotton seedlings emerged, the seedlings were established and were thinned to 33000 plant ha-1 by leaving one vigorous plant per hill at the two-true-leaf stage. The actual harvested density was 31200 plant ha⁻¹. The first fruiting branch and the above tips were cut off after early squaring stage (on June 13), and only VBs retention for growth and development, squaring, and setting bolls, and no other pruning and topping were conducted. A compound fertilizer (N: P₂O₅: K₂O=15%: 15%: 15% in weight percentage) of 30 kg/mu was basal applied before seeding, with a topdressed urea at 225 kg ha⁻¹ after the cotton is headed, and no top-dressing thereafter. Chemical control with mepiquat chloride at a dosage of 30 and 60 kg ha⁻¹ was carried out at the early flowering and boll-setting stages, respectively. Other field management practices, including irrigation, tillage, and insect and weed control, were conducted according to local agronomic practices.

At the boll-opening stage, the middle 4 rows of each plot were selected, and opened bolls were picked in turn, and the total number of bolls was recorded; after nuture air-drying, bolls were weighed to calculate the boll weight and seed cotton yield, and ginned to calculate the lint percentage; five consecutive and representative cotton plants were dug from each plot, dried and weighed, and the biomass yield was recorded. The harvest index was calculated in combination with the seed cotton yield data. The results were shown in Table 2.

TABLE 2
Effects of plant pruning on cotton yield, yield components and harvest index

| | Boll | Boll | Lint | Seed cotton | Biomass | Harvest |
|---|---|---|---|---|---|---|
| | density | weight | percentage | yield | yield | index |
| Factors | (No. m⁻²) | (g) | (%) | (kg ha⁻¹) | (kg ha⁻¹) | (%) |
| only FB retention | 82.5 c | 5.3 a | 44.52 a | 4373 b | 10568 c | 41.4 a |
| only VB retention | 108.4 a | 4.5 c | 43.38 a | 4878 a | 13854 a | 35.2 c |
| no pruning | 95.8 b | 4.8 b | 44.01 a | 4598 b | 12094 b | 38.0 b |

NOTE:
FB and VB represent fruiting branch and vegetative branch respectively. Values within a column followed by different letters indicate a significant difference at p = 0.05.

The results showed that the method (only VB retention) greatly increased the biological yield of cotton, which promoted the boll setting of cotton plants, and increased the seedcotton yield. Compared with the treatments of only FB retention and no pruning, only VB retention increased boll density by 31.4 and 13.2% respectively, decreased boll weight by 15.1 and 6.3%, increased seed cotton yield by 11.6 and 6.1%, increased biological yield by 31.1 and 14.6%, decreased harvest index by 14.9 and 7.4%.

### Example 3

This study was conducted at the Experimental Station in Linqing (115° 42′E, 36° 61′N) of the Institute of Industrial Crops, Shandong Academy of Agricultural Sciences, with Gossypium hirsutum cv. Lumian 338 as the test material.

The experimental setting proposal were as follows: no pruning (VBs and FBs retension, NP), only FBs retension (all VBs were manually removed after squaring), and only VBs retention(all main stems and FBs above the VBs were cut off after squaring) were set up.

Specific steps were as follows:

1) Cottonseeds were sown on April 20 with 4 repetitions, in 8 row plots. The cotton was planted in an equal row spacing of 76 cm, with a row length of 10 m. According to the local fine management requirements, both removal of VBs and retention of VBs alone were carried out on June 15 (squaring stage), and the VBs, main stems and FBs were manually removed.

2) After cotton seedlings emerged, the seedlings were artificially placed and established and were thinned to 33000 plant ha⁻¹ by leaving one vigorous plant per hill at the two-leaf stage, and actual plant density at harvest was 31500 plant ha′ plant/mu.

3) During the cotton developmental stage, mepiquat chloride was sprayed twice for chemical control. The spraying period was at the flowering stage and boll-forming stage, and the dosages of mepiquat chloride were 30 kg and 52.5 kg ha′, respectively.

4) Fertilization was conducted according to the economic fertilizer application rate recommended by the local agricultural technology department. A compound fertilizer (N: P₂O₅: K₂O=15%: 15%: 15% in weight percentage) of 30 kg/mu was basal applied before seeding, with a topdressed urea at 15 kg after the cotton was headed., and top-dressing was no longer needed thereafter.

Other field management practices, including irrigation, tillage, and insect and weed control, were conducted according to local agronomic practices.

After vegetative branches were treated, in each developmental stage, 6 cotton plants were randomly selected and dried, the dry matter weight of each part was weighed, the number of bolls in each plot was investigated at the flowering and boll-forming stage, and the yield was investigated at the boll-opening stage. The results were shown in Table 3.

TABLE 3
Effects of plant pruning on cotton yield, yield components and harvest index

| | Boll | Boll | Lint | Seed cotton | Biomass | Harvest |
|---|---|---|---|---|---|---|
| | density | weight | percentage | yield | yield | index |
| Factors | (No. m⁻²) | (g) | (%) | (kg ha⁻¹) | (kg ha⁻¹) | (%) |
| only FB retention | 87.2 b | 5.05 a | 44.48 a | 4402 b | 10503 b | 42.04 a |
| only VB retention | 110.9 a | 4.44 c | 43.61 a | 4912 a | 13362 a | 39.43 b |
| no pruning | 89.3 b | 4.69 b | 43.35 a | 4184 c | 11034 b | 39.06 b |
| only FB retention | 87.2 b | 5.05 a | 44.48 a | 4402 b | 10503 b | 42.04 a |
| only VB retention | 110.9 a | 4.44 c | 43.61 a | 4912 a | 13362 a | 39.43 b |
| no pruning | 89.3 b | 4.69 b | 43.35 a | 4184 c | 11034 b | 39.06 b |

NOTE:
FB and VB represent fruiting branch and vegetative branch respectively . . . Values within a column followed by different letters indicate a significant difference at p = 0.05.

The results showed that the removal of FBs and main stem tips, and relying VB-sourced bolls (only VB retention) could produce a greatly yield by the significantly increase of the boll density Compared with the traditional VBs removal (only FB retention) and no pruning, only VB retention increased the boll density by 27.2 and 24.2%, decreased boll weight by 12.1 and 5.3%, increased seedcotton yield by 11.6 and 17.4%, and increased the biological yield by 27.2 and 21.1%. It showed that relying VB-sourced bolls could not only increase cotton yield by more than 10%, but also eliminate plant punning and topping. It was a simple and feasible new method for cotton cultivation.

Finally, it should be noted that the above descriptions are only preferred examples of the present disclosure, and are not intended to limit the scope of the claim. Although the present disclosure has been described in detail with reference to the foregoing examples, those skilled in the art can still modify the technical solutions described in the foregoing examples, or equivalently substitute some technical features thereof. Other modification, equivalent substitution, improvement, etc. fall within the spirit and principle of the present disclosure shall be included within the claimed scope of the disclosure.

What is claimed is:

1. A simplified cotton cultivation method relying on setting bolls on vegetative branches(VBs), comprising the following steps: heading a cotton plant to retain only VBs when cotton grows to acquiring stage, namely cutting off a first fruiting branch and an upper main stem thereof from the cotton plant after squaring, and only retaining the VBs for growth and development, squaring, flowering, and setting bolls.

2. The simplified cotton cultivation method relying on setting bolls on VBs according to claim 1, wherein the cotton is sown on April 10 to April 20 and cultivated with plastic mulching.

3. The simplified cotton cultivation method relying on setting bolls on VBs according to claim 1, wherein a cotton planting density is around at 30,000 plants ha′.

4. The simplified cotton cultivation method relying on setting bolls on VBs according to claim 1, wherein no pruning and topping are conducted during a cotton developmental stage.

5. The simplified cotton cultivation method relying on setting bolls on VBs according to claim 1, wherein a compound fertilizer, with N: P₂O₅: K₂O=15%: 15%: 15% in weight percentage, of 450 kg ha⁻¹ was basal applied before seeding, with a topdressed urea at 225 kg ha⁻¹ after the cotton is headed, and no top-dressing thereafter.

6. The simplified cotton cultivation method relying on setting bolls on VBs according to claim 1, wherein chemical control is conducted twice during the growth period of cotton: spraying 22.5-30 kg and 45-60 kg of mepiquat chloride per hectare at the time of early flowering and when the first boll appeared, respectively, and spraying is no longer needed thereafter.
